(19) United States
(12) Patent Application Publication
(10) Pub. No.: US 2014/0238813 A1
(43) Pub. Date: Aug. 28, 2014

(54) CLAMPING BODY-SLEEVE FREEWHEEL AND METHOD FOR PRODUCING THE SAME

(71) Applicants: Frieder Altmann, Pommersfelden (DE); Swen Doerrie, Herzogenaurach (DE)

(72) Inventors: Frieder Altmann, Pommersfelden (DE); Swen Doerrie, Herzogenaurach (DE)

(73) Assignee: Schaeffler Technologies AG & Co. KG, Herzogenaurach (DE)

(21) Appl. No.: 13/996,338

(22) PCT Filed: Dec. 12, 2011
(86) PCT No.: PCT/EP2011/072393

§ 371 Date: Apr. 30, 2014

(30) Foreign Application Priority Data
Dec. 21, 2010 (DE) 10 2010 055 407.3

(51) Int. Cl. F16D 41/06

(52) U.S. Cl. CPC F16D 41/06
USPC 192/41 R; 29/428

(57) ABSTRACT

The present invention relates to a clamping body freewheel including an inner part having a circular cylindrical outside circumference, an outer part having a circular cylindrical inside circumference, and clamping bodies, which are accommodated in a gap formed by the inside circumference and the outside circumference and are arranged consecutively in the circumferential direction in a tiltable manner and are guided in openings of a cage, where the clamping bodies are arranged in a radially inwardly open sleeve, and the clamping body freewheel is introduced in the outer part by means of the sleeve in a rotationally fixed manner, and a track is formed on an inside circumferential surface of the sleeve for the clamping bodies.

### CROSS-REFERENCE TO RELATED APPLICATIONS

The present application is the U.S. national stage application pursuant to 35 U.S.C. §371 of International Patent Application No. PCT/EP2011/072393, filed Dec. 12, 2011, which claims priority from German Patent Application No. 10 2010 055 407.3, filed Dec. 21, 2010, which applications are incorporated herein by reference in their entireties.

### FIELD OF THE INVENTION

The invention relates to a clamping body freewheel and a method for producing the clamping body freewheel, including an inner part having a circular cylindrical outside circumference, an outer part having a circular cylindrical inside circumference, and clamping bodies, which are accommodated in a gap formed by the inside circumference and the outside circumference and are arranged consecutively in the circumferential direction in a tiltable manner and are guided in openings of a cage.

### BACKGROUND OF THE INVENTION

A clamping body freewheel, which conforms to its genre, such as a freewheel clutch, is known, for example, from the prior art German Patent No. 10 2008 038 060 A1. In this case the clamping bodies are held in an installation position in a cage in such a way that they are distributed over the circumference. The inside circumference of the outer part has an inside circumferential surface provided by means of suitable precision machining and hardening processes, for example bore grinding and hardening. These inside circumferential surfaces form the track for the clamping bodies.

Precision machining of the outer part is time consuming and usually reserved for the customer. Since the production and assembly steps of the cage with the clamping bodies and of the outer part are separated, for example, between the supplier side and the customer side, a close coordination of the surface finish, the tolerance and the hardness is necessary.

The installation of the cage with the clamping bodies, which must be positioned exactly in the inside circumference, on the inside circumference of the outer part is time-consuming and subject to errors and is performed only with reluctance by the user in-house.

### BRIEF SUMMARY OF THE INVENTION

Therefore, the object of the present invention is to propose a cost effective clamping body freewheel that can be easily installed by the customer and allows a reduction in the complexity of the outer parts.

This engineering object is achieved by means of a clamping body freewheel, such as a clamping body-sleeve freewheel, including an inner part having a circular cylindrical outside circumference, an outer part having a circular cylindrical inside circumference, and clamping bodies, which are accommodated in a gap formed by the inside circumference and the outside circumference and are arranged consecutively in the circumferential direction in a tiltable manner and are guided in openings of a cage, where the clamping bodies are arranged in a radially inwardly open sleeve, and the clamping body freewheel is introduced in the outer part by means of the sleeve in a rotationally fixed manner, and a track is formed on the inside circumferential surface of the sleeve for the clamping bodies. This example embodiment of a clamping body freewheel allows the contact face between the clamping bodies and the outer part to be moved into the subassembly with the clamping bodies, where the subassembly fixes the function of a clamping body freewheel as a delivery component; and all of the tracks of the clamping body freewheel are provided in one subassembly. In this way the tracks of the clamping body freewheel can be fine tuned to one another. At the same time the inside circumference of the outer part can be simplified, because the material and surface condition of the inside circumference of the outer part has to be prepared only for receiving the sleeve. For example, it is possible to dispense with the precision machining steps, such as bore grinding and hardening processes on the inside circumference. According to one exemplary embodiment, the sleeve can be pressed to the outer part, for example, by means of a force fit, so that no additional measures have to be taken on the inside circumference of the outer part, save for the tolerances for the fit.

According to the inventive idea, one exemplary embodiment is provided with a sleeve, which in the raw state is constructed in the shape of an L in the cross section, and, after insertion of the clamping bodies, is flanged in order to form a U-shaped cross section. Such a sleeve can be deep drawn in an off-tool manner as a blank; the hardening processes are applied only if desired. In this case the quality of the off-tool surface of the sleeve is adequate for forming the outside circumference with respect to the outer part and for forming the track for the clamping bodies. For example, the cage with the clamping bodies, which are received in the cage in such a way that they are ensured against loss, is inserted into an L-shaped blank. Then the outside circumference of the sleeve is flanged radially inwards, thereby producing the radially inwardly open sleeve that is shaped like a U in the cross section.

Owing to the two radially inwards drawn walls, like flanges of the sleeve, the clamping bodies are supported axially on both sides. This rigid embodiment of the subassembly with the clamping bodies significantly simplifies the installation of the subassembly on the outer part.

Moreover, the subassembly including the sleeve, the cage and the clamping bodies can be pulled onto a track of the inner part, where the track has been prepared for the purpose of satisfying the required hardness and surface properties. However, it can also be advantageous to provide, in addition to the track for the outer part, also the track for the inner part on the subassembly with the clamping bodies. For this purpose an inner ring, for example, a solid inner ring or an inner ring made of sheet metal, can be accommodated on the interior side of the clamping bodies of a corresponding subassembly. In this case this inner ring has a matching inside circumference and is fastened to, for example shrunk on, the inner part during the assembly in such a way that it is rotationally rigid. In this way the track of the inner ring can also be provided by the manufacturer of the subassembly.

The outer ring can be an annular part with the inside circumference for the sleeve; or the outer ring can be a housing, in which a corresponding circularly round receiving opening is provided. The inner part can be, for example, a shaft. The clamping body freewheel can be used, for example in drive units as actors or electric motors, and in industrial applications or motor vehicles. When the clamping body freewheel is in idle mode or overrunning mode in one direction of rotation, the drive units are uncoupled; and when the clamping body freewheel is in the locking mode in the other direction of rotation, the drive units transmit a torque to a device that is to be driven or more specifically enable a freewheeling in one direction of rotation and lock or brake against a housing in the other direction of rotation.

Furthermore, the engineering object is achieved by means of a method for producing a clamping body freewheel having an inner part having a circular cylindrical outside circumference, an outer part having a circular cylindrical inside circumference, and clamping bodies, which are accommodated in a gap formed by the inside circumference and the outside circumference and are arranged consecutively in the circumferential direction in a tiltable manner and are guided in openings of a cage, where the clamping bodies are inserted into a sleeve that has the shape of an L in the cross section, and the sleeve is flanged radially inwards on one side in order to form a U-shaped cross section, and the sleeve is pressed to the inside circumference of the outer part.

### BRIEF DESCRIPTION OF THE DRAWINGS

The nature and mode of operation of the present invention will now be more fully described in the following detailed description of the invention taken with the accompanying drawing figures, in which:

FIG. 1 is a sectional view of a clamping body freewheel; and,

FIG. 2 is a schematic sectional view of the clamping body freewheel from FIG. 1 along an additional sectional plane.

### DETAILED DESCRIPTION OF THE INVENTION

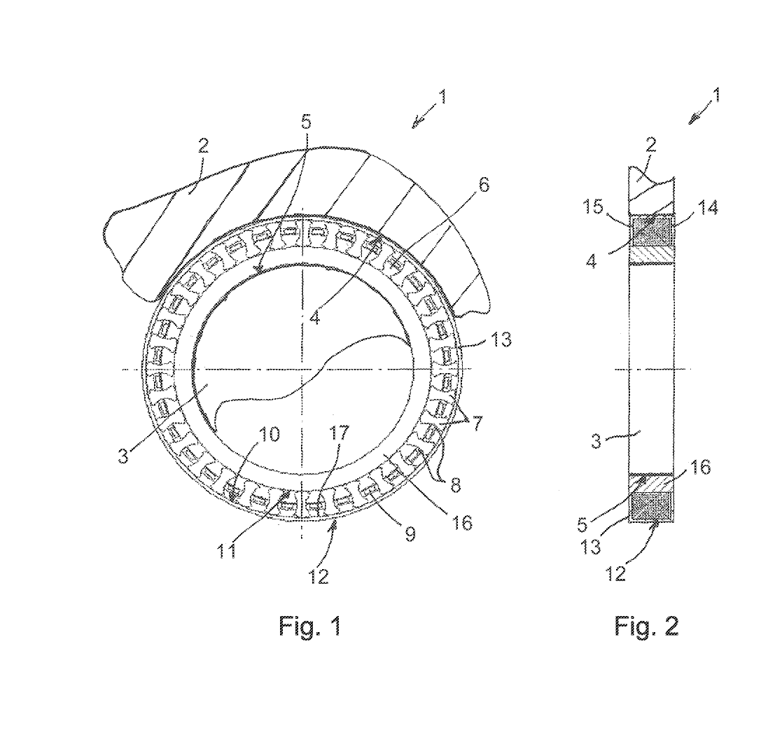

FIGS. 1 and 2 show clamping body freewheel 1 along two sectional planes with outer part 2 and inner part 3. Outer part 2 has circular cylindrical inside circumference 4, and inner part 3 has circular cylindrical outside circumference 5. The outer part and the inner part enclose gap 6, in which clamping bodies 7 are distributed over the circumference and are arranged consecutively in the circumferential direction in a tiltable manner. The clamping bodies, which are positioned at defined intervals, are received in openings 8 of cage 9 in a pivotable manner, so that in the event of a relative rotation of outer part 2 and the inner part in a first direction of rotation, clamping body freewheel 1 switches into the overrunning mode, in which clamping bodies 7, pivoting on a small effective radius, slide on tracks 10 and 11 associated with inner part 3 and outer part 2. In the event of a reversal of the direction of rotation, clamping bodies 7, designed to be asymmetrical with respect to their sliding radii, pivot in the opposite direction of rotation and, in so doing, at larger effective radii and, as a result, block the rotational mobility of inner part 3 and outer part 2 in relation to one another.

In order to shift the accuracy of the tolerance of track 10 to the manufacturer of subassembly 12, formed by clamping bodies 7 and the cage, radially inwards open sleeve 13 is integrated into subassembly 12 radially outside clamping bodies 7. This sleeve forms track 10 by means of inside circumferential surface 17 and is pressed into outer part 2. In this way a time-consuming machining of inside circumference 4 of the outer part is reduced. Sleeve 13 is produced, for example, by means of a deep drawing process, for example, as a blank that has the shape of an L in the cross section. The sleeve includes track 10 in an off-tool manner. During the assembly of cage 9, which is populated with clamping bodies 7, one of walls 14, 15 serves as an axial stop, whereas other wall 15, 14 is produced by flanging after the insertion of cage 9.

The adjustment of the accuracy and tolerance of track 11 can be done by means of inner ring 16, which is integrated radially inwards into subassembly 12 such that this adjustment can be integrated into the sphere of the manufacturer of the track. In this context at least track 11 of inner ring 16 can be hardened Inner ring 16 is connected to, for example, shrunk onto, inner part 3 in a rotationally fixed manner. It goes without saying that inner ring 16 and inner part 3 can be constructed as a single piece. In this case subassembly 12 is formed by sleeve 13 and cage 9, which is inserted into this sleeve, with clamping bodies 7. Then the installation of subassembly 12 of clamping body freewheel 1 is carried out by pushing onto inner part 3 with track 11 that has been prepared for this purpose.

### LIST OF REFERENCE NUMERALS

1 clamping body freewheel
2 outer part
3 inner part
4 inside circumference
5 outside circumference
6 gap
7 clamping body
8 opening
9 cage
10 track
11 track
12 subassembly
13 sleeve
14 wall
15 wall
16 inner ring
17 inside circumferential surface

What is claimed is:

1-7. (canceled)

8. An apparatus for a clamping body freewheel, comprising:
an inner part having a circular cylindrical outside circumference;
an outer part having a circular cylindrical inside circumference; and,
clamping bodies, which are accommodated in a gap formed by the inside circumference and the outside circumference and arranged consecutively in a circumferential direction in a tiltable manner and are guided in openings of a cage, comprising:
clamping bodies arranged in a radially inwardly open sleeve;
the clamping body freewheel is introduced in the outer part by means of the sleeve in a rotationally fixed manner; and,
a track is formed on an inside circumferential surface of the sleeve for the clamping bodies.

9. The apparatus recited in claim 1, wherein the sleeve in a raw state is constructed in the shape of an L in the cross section, and, after insertion of the clamping bodies, is flanged in order to form a U-shaped cross section.

10. The apparatus recited in claim 2, wherein the sleeve is deep drawn in an off-tool manner.

11. The apparatus recited in claim 1, wherein the sleeve is pressed into the outer part.

12. The apparatus of claim 1, wherein the clamping bodies are supported axially on both sides by means of a wall of the sleeve.

13. The apparatus of claim 1, wherein a subassembly comprising the cage, the clamping bodies, and the sleeve has an inner ring having an inside circumference with a track for the clamping bodies, wherein the inner ring is connected to the inner part by means of a press fit.

14. A method for producing a clamping body freewheel, comprising:
an inner part having a circular cylindrical outside circumference;
an outer part having a circular cylindrical inside circumference; and,
clamping bodies, which are accommodated in a gap formed by the inside circumference and the outside circumference and arranged consecutively in a circumferential direction in a tiltable manner and guided in openings of a cage,
wherein the clamping bodies are inserted into a sleeve that has the shape of an L in the cross section;
the sleeve is flanged radially inwards on one side in order to form a U-shaped cross section; and,
the sleeve is pressed to the inside circumference of the outer part.
